(19) United States
(12) Patent Application Publication
(10) Pub. No.: US 2008/0265741 A1
(43) Pub. Date: Oct. 30, 2008

(54) SEMI-FULL HELICAL LUMINOUS ELECTRONIC ENERGY-SAVING LAMP

(75) Inventors: Chun-Tsun Chen, Shanghai (CN); Robin Zheng, Shanghai (CN)

Correspondence Address: FULWIDER PATTON LLP, HOWARD HUGHES CENTER, 6060 CENTER DRIVE, TENTH FLOOR, LOS ANGELES, CA, 90045, US

(73) Assignee: CRYSTAL GREEN LIGHTING CO., LTD., Shanghai (CN)

(21) Appl. No.: 12/025,344

(22) Filed: Feb. 4, 2008

(30) Foreign Application Priority Data
Apr. 29, 2007 (CN) 200720069619.3
Aug. 1, 2007 (CN) 200720073207.7

(51) Int. Cl. H01J 1/62; H01J 17/16

(52) U.S. Cl. 313/493; 313/635

(57) ABSTRACT

A semi-full helical luminous electronic energy-saving tube and an electronic energy-saving lamp using the tube are disclosed. The structure at the connection between the end of tube and the enclosure is a straight section. An inward bend of the straight section is achieved via an interface point between the straight section and the helical portion of the tube. The interface point includes a sharp, V-shaped 180° backward bend. By making use of the sharp inward bend, a sufficient space is left for the enclosure process.

### CLAIM OF FOREIGN PRIORITY UNDER 35 U.S.C. §119

This application claims priority under 35 U.S.C. § 119 from Chinese Patent Application No. 200720069619.3 by Robin Zheng, filed Apr. 29, 2007, and from Chinese Patent Application No. 200720073207.7 by Chun-Tsun Chen, filed Aug. 1, 2007, which disclosures are hereby incorporated by reference.

### BACKGROUND OF THE INVENTION

The present invention relates to an electronic energy-saving lamp, and specifically relates to a semi-full helical luminous electronic energy-saving tube and the electronic energy-saving compact fluorescent lamp (CFL) containing the luminous tube.

The electronic energy-saving lamp generally consists of an enclosure, a lamp base, a tube, and a ballast. Among them, the tube and lamp base are fixed on the enclosure and the ballast is installed inside the enclosure.

There are various types of tubes used in electronic energy-saving lamps. For example, Chinese Patent No. 02216802.8 discloses an electronic energy-saving lamp with full helical luminous tube. Its luminous tube is generally formed by a straight tube, and after helical coiling, encapsulation, and vacuum fabrication processes, is installed and fixed on an enclosure along the tangential direction of the helix. However, the following problems exist with an electronic energy-saving lamp with such a construction: (1) The outer diameter of the enclosure needs to be larger than the external outer diameter of the tube in order to fully enclose it, so a lot of material for the enclosure is wasted. (2) The tube is cut off along the axis of helix, which tube is easy to deform through the processing but tends to create stress at that location. So during lamp fabrication, the process of enclosing the tube stem decreases the pass rate due to quality control issues. (3) Finally, this tube design is difficult to adapt to automation again due to the quality consistency issue.

Chinese Patent No. 02268192.2 discloses an umbrella shaped helical luminous tube. Its tube is cut off on the helical axis line and there is a straight tube perpendicular to the enclosure. Although this tube structure solved the problems of a tube stem enclosure that existed in the lamp fabrication process, the fabrication costs are relatively higher as compared with the former design.

### SUMMARY OF THE INVENTION

Two technical problems solved by the present invention semi-full helical luminous electronic energy-saving tube and a CFL using such a tube are to meet market demands for an inexpensive light source, and to address energy efficiency of such a light source.

One feature of the present invention is to provide a semi-full helical luminous electronic energy-saving tube having a connection between an end of the tube and the enclosure through a straight section. This embodiment is achieved via an interface point between a straight section of the tube and helical portion, wherein the interface point includes an elbow-like, V-shaped backward bend of about 180 degrees.

In various embodiments, the tube is formed by coiling a straight glass tube. The coiling can be in a columnar, full helical form with uniform upper and lower parts, or an umbrella-shaped or tapered form with smaller upper and bigger lower parts. The number of coils may depend on the power or wattage of the lamp. The tube preferably has about a 1 mm-38 mm diameter and preferably about a 2 mm-60 mm length at the straight section by the interface point.

The semi-full helical luminous electronic energy-saving lamp of the present invention includes an enclosure, a tube, and a lamp base. The tube is a semi-full helical luminous electronic energy-saving tube, which has all the features of a semi-full helical luminous electronic energy-saving tube described above, including a straight section at the end of the tube, wherein the straight section is inserted into the enclosure where the intersection with the enclosure bottom plane is at a declined angle of the straight section.

Furthermore, in the present invention, there are two inclined tube holes on the enclosure bottom plane used to receive the two declined angle straight sections of the tube. The two straight sections of the tube are inserted into the two inclined tube holes.

A position limitation board is provided in the inclined tube hole to limit the depth of insertion of the straight section of the tube. This minimizes heat transfer from the hot tube end into the enclosure where the ballast resides. The heat reduces the reliability and life of the ballast. A hole is formed on the position limitation board for passing through the stem of tube.

To save the material for the enclosure, at least one part of the inclined tube hole protrudes from the bottom plane of the enclosure.

The directions of the two inclined tube holes are opposite to each other and are symmetrical to a center axis of the enclosure.

Some advantages of the present invention are: (1) Since the stem is enclosed or clipped on the tube straight section, which is not deformed because it is not processed, there is a good quality consistency. (2) By making use of the sharp inward elbow bending, sufficient space is created for the enclosure assembly process. Therefore, the pass rate of fabrication is improved significantly. (3) In addition, the enclosure size of the entire lamp after inward bending is now dependent on the ballast's size. In earlier designs, the enclosure size was dependent on what size the helical tube could be packaged in, which was much larger without the inward elbow bend. Thus, the costs of enclosure materials can be saved.

### BRIEF DESCRIPTION OF THE DRAWINGS

FIG. 1 is a side elevational view of a preferred embodiment of a semi-full helical luminous electronic energy-saving lamp.

FIG. 2 is a side elevational view of the lamp of FIG. 1 rotated 90 degrees along a vertical axis.

FIG. 3 is the top plan view of the lamp in FIG. 1.

FIG. 4 is the bottom view of the lamp in FIG. 1.

FIG. 5 is a bottom perspective view showing the connection between the semi-full helical luminous electronic energy-saving tube and the enclosure.

FIG. 6 is the detailed side elevational view showing the connection between the semi-full helical luminous electronic energy-saving tube and the enclosure.

FIG. 7 is a side elevational view of a preferred embodiment tube.

FIG. 8 is a bottom view of the tube from FIG. 7.

FIGS. 9(a) and (b) are two side elevational views of a prior art CFL helical tube lamp.

### DETAILED DESCRIPTION OF THE PREFERRED EMBODIMENTS

To facilitate the understanding of the technical means, creative features, and effectiveness realized in the present invention, preferred embodiments of the invention are further described below in combination with the specific drawing figures.

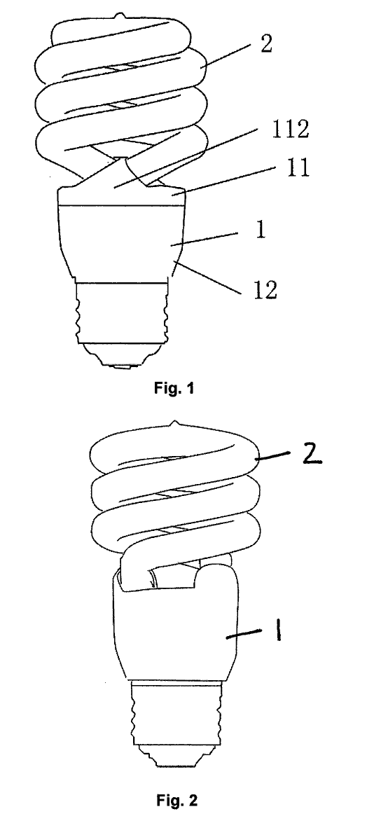

The present invention generally relates to a compact fluorescent lamp (CFL) and the tube used in such a lamp. In the preferred embodiment shown in FIGS. 1, 2, 3 and 4, the semi-full helical luminous electronic energy-saving lamp includes an enclosure 1, a coiled, helical shape tube 2, and a lamp base having external threads (not shown) with metallic contacts to be screwed into a standard incandescent light bulb socket. The shape of the helical tube has two features—a straight section diverging from the continuous curve of the helix, and a sharp elbow forming a 180° backward bend.

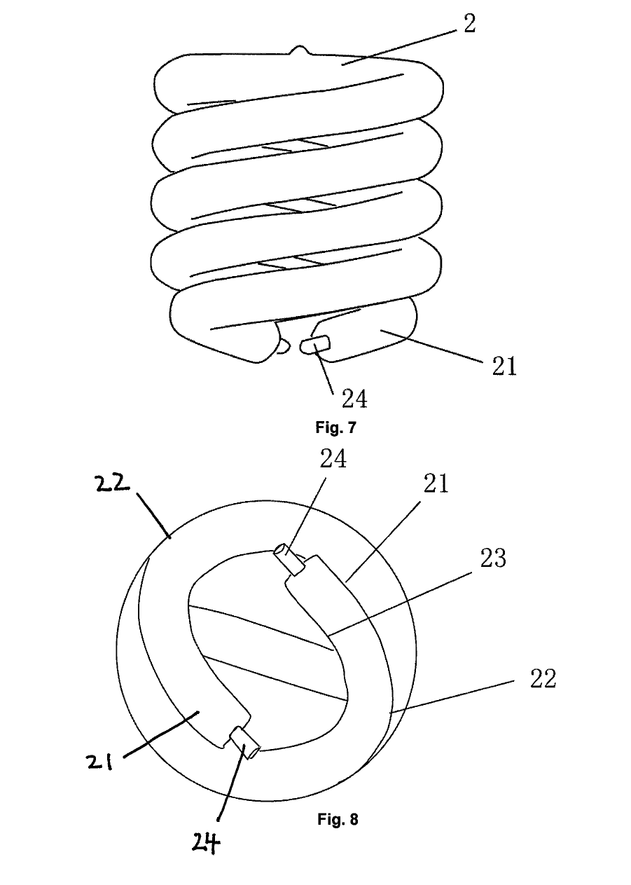

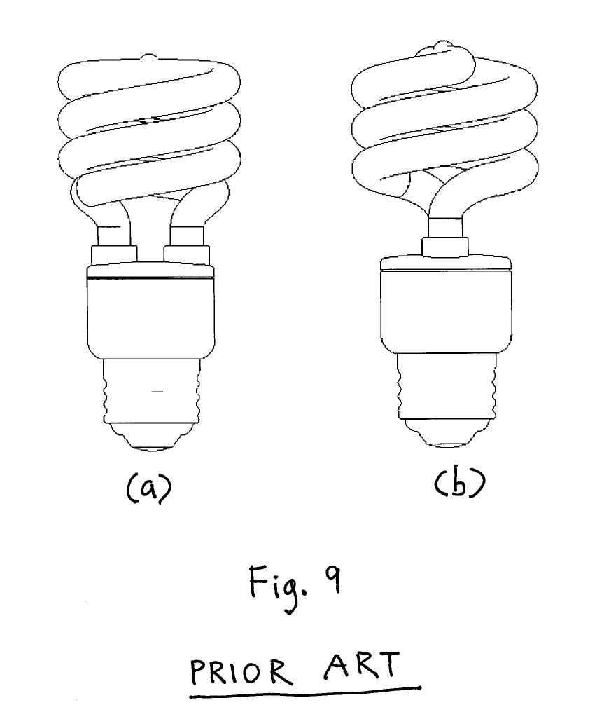

For example, in FIGS. 7 and 8, the structure at the connection between the end of the tube 2 and the enclosure 1 is straight section 21. One end of the straight section 21 is sharply bent inward toward the center axis of the coiled helix of the tube. An interface point 23 between the straight section 21 and the 180° backward elbow bend 22 of the tube can be located on the straight section 21 or the 180° backward elbow bend 22.

In conventional helical tubes, the curve of the helix is continuous so when the tube is cut to size, the tube is cut off along the axis of helix. When such a cut curved end is then processed, the tube size deforms easily, and the cut creates stress at that location, which decreases the tube pass rate when enclosing the end with a stem. Accordingly, due to these complication, it is difficult to adapt a conventional helix tube to production automation. According to one embodiment of the present invention, however, the helix shaped tube includes a straight section 21. The straight section 21 diverges from the continuous, natural curve of the helical shape tube. The stresses at the cut if made in the straight section 21 are eliminated and the other production problems are minimized.

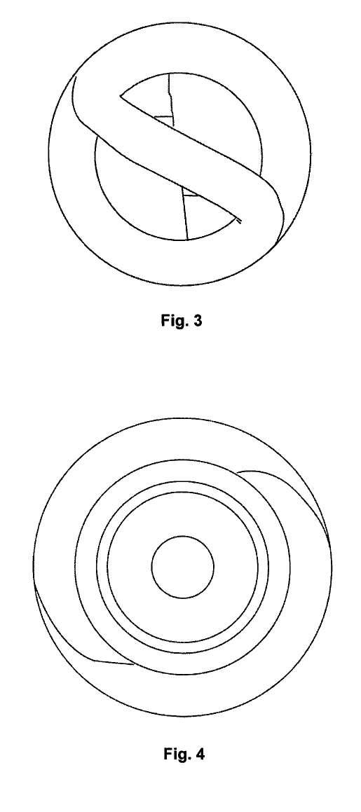

There is a conventional helical tube shape as seen in FIG. 9, which has ends that have straight section formed parallel to the longitudinal axis of coiled helical shape tube. Because it is necessary to bend the straight ends to be parallel and approach exactly vertically into the lamp base, and because such bending is complicated, special-skilled manual techniques are required. Because of this skilled manual manipulation of the tubing, such a tube shape is very difficult to adapt to production automation. In contrast, the present invention semi-full helical tube shape as seen in FIGS. 1 and 2, for example, there is only need to bend the tube at a small angle. No special skill is needed. Finally, the range of processing of the bent tube is smaller than with the FIG. 9 conventional tube, so the present invention semi-full helical tube is more easily formed and more easily meets quality control standards for higher pass rates.

The 180° backward elbow bend 22 preferably has a sharp elbow kink as seen in FIG. 8, having a V-shape rather than a large-radius, gentle curve. The inward extending straight section along with the sharp kink bend dramatically improve the packaging efficiency of the tube, making the overall size of the CFL smaller, and requiring a smaller enclosure as mentioned earlier. Such a sharp kink bend is unexpected in glass tube processing since the brittleness of glass suggests a gentle bend to reduce stress in that area. In high production, a large-radius bend with low stress would presumably result in higher quality control pass rate. However, through empirical observation, the 180° backward elbow bend 22 unexpectedly maintains high pass rates as well.

Furthermore, the sharp 180° backward elbow bend 22 would suggest an impaired electrical conduction between the two electrodes at the opposite stems 24 of the tube 2. The possible impaired electrical conduction would thus create problems in illuminating the tube 2. However, as empirical observations have unexpectedly demonstrated, the sharp kink bend 22 does not impair ignition of the plasma contained in the tube 2 or the consistent illumination of the tube 2 during normal operation of the CFL.

The helical shaped tube 2 is formed from coiling an initially straight glass tube. The coiling can be a columnar, full helical form with even or uniform upper and lower parts, or in an alternative embodiment, an umbrella or tapered form with smaller upper and bigger lower parts. The number of coils for the tube 2 is usually dependent on the power or wattage of the lamp.

The tube 2 can be about 1 mm-38 mm in diameter and about 2 mm-60 mm in length at the straight section 21 at or adjacent the interface point 23.

The fabrication of the tube 2 preferably follows the following steps: the straight glass tube is heated and formed into a helical shape on a helical tube bending mold or fixture. The helical tube is processed and specifically reheated at and around the interface point 23 for a second time to create the sharp, small-radius V angle 22, and to form the inward-extending straight section 21. Then the redundant distal portion of the straight section 21 is cut off, leaving the desired length for the straight section 21, which upon cooling completes the glass tube processing.

Next, the tube 2 is coated with fluorescent powders like phosphor, and ambient air is evacuated from the tube 2. The tube 2 is filled with a gas that contains mercury and argon or the like. Then the mouth of the straight section 21 is sealed by a stem 24. The stem 24 includes a filament or electrode for electrical conduction. As seen in FIG. 8, the tube 2 has two straight sections 21 with respective filaments at each end.

As seen in FIG. 6, after the two ends 24 have been sealed, the two straight sections 21 of the tube 2 are inserted into two inclined tube holes 112 in a base plate 11. The holes 112 are essentially sleeves with respective through-holes. The tube 2 is connected with a ballast (not shown) held inside the enclosure 1 via the filaments. After adding the upper cover 12 and installing the lamp base, the assembly of the semi-full helical luminous electronic energy-saving lamp is generally complete.

As seen in FIGS. 1, 2, 3 and 4, the enclosure 1 has a cavity formed by the base plate 11 and upper cover 12. A standard ballast is installed in the cavity.

As described above, on the bottom plane 111 of the base plate 11, there are two inclined (upward opening) tube holes 112 drilled or otherwise formed therein for insertion of the two declined (downward pointing) straight sections 21 of the tube 2. The angle between a center axis of each inclined tube hole 112 and the bottom plane 111 of base plate 11 can be determined as required to be similar to the pitch angle of the helical tube, or to be greater (or lesser) as shown in FIG. 6.

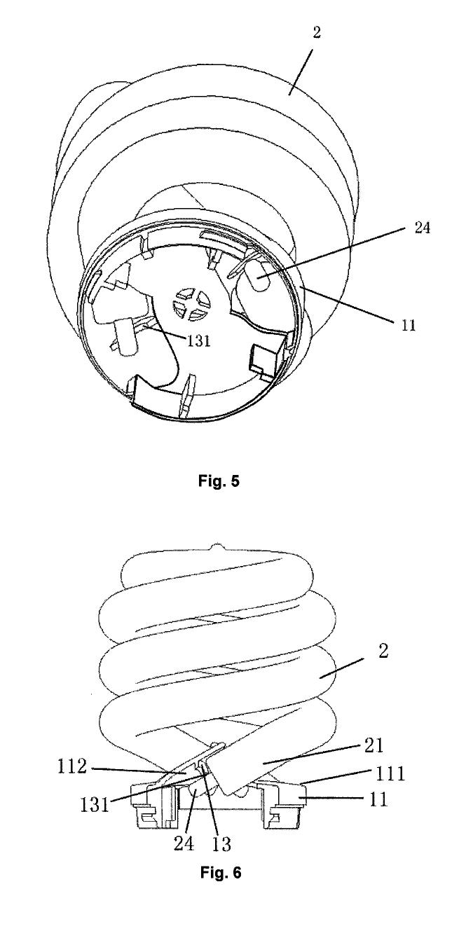

From FIGS. 5 and 6, an optional position limitation board or stop 13 is provided in the inclined tube hole 112 to limit or confine the depth of insertion of the straight section 21 of the tube 2. A stem hole 131 is formed on the position limitation board 13 for passing the stem 24 of the tube 2 therethrough. By making use of the position limitation board 13, the consistency and repeatability of depth of insertion of the tube 2 into the enclosure 1 can be maintained consistently and the assembling efficiency is improved.

Relating to the depth of insertion of the tube 2, as seen in FIG. 6, the tube holes 112 for insertion of tube ends/stem 24 are at the bottom plane 111 of the enclosure 1 and do not extend substantially into the interior of enclosure 1. One reason to control depth of insertion is to separate thermally the tube from the ballast component. The ends of tube are a primary source of heat. So if the tube ends/stem 24 are inserted too far into the enclosure 1 approaching the interior sidewall, the hot tube ends 24 will reach the location of ballast. As a result, the heat generated inside the enclosure 1 will detrimentally affect the reliability and operational life of ballast. On the other hand, when the majority of the straight section 21 and the tube end/stem 24 remain outside of the enclosure 1, ambient air helps dissipate the heat generated in that region. As seen in FIG. 6, it is therefore preferable that the tube ends/stem 24 do not extend substantially past the bottom plane 111 of the base plate 11.

Preferably, at least a part of the inclined tube hole 112 protrudes from the bottom plane 111 of base plate 11 so that the height of the entire base plate 11 is lowered. The opening directions of the two inclined tube holes 112 are opposite to each other, and the holes 112 are located symmetrical to the longitudinal axial centerline of the enclosure 1, which coincides with the center axis of the helical tube.

The above shows and describes the basic principles and major features of this invention. A person skilled in the art shall understand that this invention is not limited by the above-described exemplary embodiments, which are intended to describe the principles and features of the of the invention. It is therefore possible, without deviating from the spirit and scope of this invention, to incorporate various changes and improvements to this invention, which will fall within the scope of the invention. The scope of this invention is therefore more properly defined by the attached claims.

We claim:

1. A semi-full helical luminous electronic energy-saving tube for use in a compact fluorescent lamp, comprising:
a luminous tube having two ends, wherein the tube includes a helical shape;
wherein the tube proximate to each end includes a straight section that is bent inward toward a center axis of the helical shape, an interface point transitioning between the straight section and a helical portion of the tube, wherein the interface point includes a backward 180° elbow bend.

2. The semi-full luminous electronic energy-saving tube according to claim 1, wherein the tube includes a helical coil shaped formed from a straight glass tube, and the helical coil includes at least one of a columnar full helical form with even upper and lower parts, and an umbrella shaped form with smaller upper and bigger lower parts.

3. The semi-full luminous electronic energy-saving tube according to claim 2, wherein the tube includes a diameter of about 1 mm-38 mm and a length of about 2 mm-60 mm at the straight section.

4. The semi-full luminous electronic energy-saving tube according to claim 1, wherein the backward 180° elbow bend includes a sharp, V-shaped kink in the tube.

5. The semi-full luminous electronic energy-saving tube according to claim 1, wherein a straight glass tube is heated and formed into a helical tube on a helical tube bending mold, and the helical tube is processed at the interface point for a second time by heating and bending inward at a certain spatial angle to form a sharp elbow kink and the straight section, and a redundant part of the straight section is cut off, and wherein the tube is coated with powders, ambient air is evacuated therefrom, and a mouth of the straight section is sealed closed by a stem, and wherein the stem includes a filament.

6. A semi-full helical luminous electronic energy-saving lamp, comprising:
an enclosure;
a helical shape continuously curved tube having two ends having respective straight sections proximate thereto, wherein the straight section diverges from the continuous curve of the helical shape of the tube;
a lamp base; and
wherein the two ends of the tube engage the enclosure at the straight sections of the tube such that an intersection thereof is with an enclosure bottom plane in a declined angle.

7. The semi-full luminous electronic energy-saving lamp according to claim 6, wherein the straight section does not pass substantially through the enclosure bottom plane into the enclosure.

8. The semi-full luminous electronic energy-saving lamp according to claim 6, wherein the straight section is bent inward such that an interface point between the straight section and a helical portion of the tube includes a sharp V-shaped, 180° bend.

9. The semi-full luminous electronic energy-saving lamp according to claim 6, wherein the tube is formed coiling a straight glass tube, and wherein the coil includes at least one of a columnar full helical form with even upper and lower parts, and an umbrella shaped form with smaller upper and bigger lower parts.

10. The semi-full luminous electronic energy-saving lamp according to claim 6, wherein the straight section of the tube includes a diameter of about 1 mm-38 mm and a length of about 2 mm-60 mm.

11. The semi-full luminous electronic energy-saving lamp according to claim 6, wherein a base plate disposed on the enclosure includes two inclined tube holes for insertion of the two declined angle straight sections of the tube.

12. The semi-full luminous electronic energy-saving lamp according to claim 11, wherein a position limitation board is disposed within each inclined tube hole to limit the depth of insertion of the straight section of the tube, and wherein the position limitation board includes a stem hole for passing a tube stem therethrough.

13. The semi-full luminous electronic energy-saving lamp according to claim 11, wherein at least a part of the inclined tube hole protrudes through the bottom plane of the enclosure.

14. The semi-full luminous electronic energy-saving lamp according to claim 11, wherein the two inclined tube holes are oriented in opposite directions to each other and symmetrically about a longitudinal axis of the enclosure.

15. A semi-full helical luminous electronic energy-saving lamp, comprising:
a helical shape fluorescent tube having two ends located at a bottom thereof, wherein each end includes respective straight sections proximate thereto;
a sharp V-shaped bend transitioning from a helical portion of the tube and the straight section of the tube at each end;
a base plate having two inclined tube holes facing opposite directions, wherein the straight sections of the tube are inserted therethrough;
a ballast connected to the ends of the tube;
an enclosure housing the ballast and covered by the base plate; and
a threaded lamp base with electrical contacts connected to the ballast.

16. The semi-full helical luminous electronic energy-saving lamp of claim 15, wherein the two inclined tube holes each includes a position limitation board that provides a stop for the inserted ends of the tube.
